(19) United States
(12) Patent Application Publication
(10) Pub. No.: US 2006/0017261 A1
(43) Pub. Date: Jan. 26, 2006

(54) Hitch guard

(76) Inventor: Robert E. Rickey, Clermont, FL (US)

Correspondence Address: EDWARD M. LIVINGSTON, PA, 963 TRAIL TERRACE DRIVE, NAPLES, FL, 34103, US

(21) Appl. No.: 10/899,469

(22) Filed: Jul. 26, 2004

(51) Int. Cl. B60D 1/60

(52) U.S. Cl. 280/507

(57) ABSTRACT

A hitch guard (1) having a horseshoe shape comprising a rigid body (2), preferably made of steel, surrounded by a soft peripheral covering (3), preferably made of a soft rubber. The device attaches to a tow hitch (9) by sliding it under a ball base (10) after a nut (11) is slightly loosed from the tow hitch arm (12). Once the U-shaped opening (4) is under the ball base (10) near the U-shaped side (5), the nut (11) is tightened to hold the device in place under the ball base (10). The hitch guard (1) may remain on the vehicle tow hitch (9) at all times, even during non-use, so a user does not have to remove and reinstall it to the tow hitch (9).

### BACKGROUND OF THE INVENTION

This invention relates to tow hitches and, more specifically, to a hitch guard that prevents injuries to a person if he or she should hit against the sharp edges of a tow hitch on a back of a vehicle.

Current hitch guards may prevent a person from injuring himself or herself on a tow hitch on the back of a vehicle. However, these guards are not securely fastenable to the hitches. In addition, these guards are not able to withstand moderate force as they are commonly made of a lightweight material, such as foam or plastic. Thus, if a person utilizing a current hitch guard had a slight force exerted upon the hitch, for example, from a low speed rear end accident or from backing up into an object, the hitch guard and hitch would become damaged.

Thus, the need exists for a new hitch guard that accommodates various tow hitches, is securely fastenable to the hitch, prevents injury to someone who walks into a hitch and is made of a durable material so as to withstand force caused by other cars hitting the hitch, a user backing the hitch into another object and similar accidents.

The relevant prior art includes the following patents:

| Patent No. | | |
|---|---|---|
| (U.S. unless stated otherwise) | Inventor | Issue Date |
| 5,575,494 | DeVries | 11-19-1996 |
| Des. 422,951 | Everett | 04-18-2000 |
| 6,039,339 | Bello | 03-21-2000 |
| 6,322,094 | Poe | 11-27-2001 |
| 6,412,806 | Peacock | 07-02-2002 |
| 4,955,968 | Beckerer, Jr. | 09-11-1990 |
| Des. 273,778 | Ruhland | 05-08-1984 |
| Des. 316,069 | Yocum | 04-09-1991 |

### SUMMARY OF THE INVENTION

The primary object of the present invention is to provide a hitch guard that protects a person from becoming injured if he or she bumps into a tow hitch.

Another object of the present invention is to provide a hitch guard that is easy to install.

A further object of the present invention is to provide a hitch guard that permits a tow hitch to be used when the hitch guard is in place.

An even further object of the present invention is to provide a hitch guard that is durable.

An additional object of the present invention is to provide a hitch guard that is able to withstand light to moderate impact.

An even additional object of the present invention is to provide a hitch guard that is aesthetically pleasing.

The present invention fulfills the above and other objects by providing a hitch guard having a horseshoe shape comprising a sturdy body, preferably made of steel, surrounded by a soft peripheral cover, preferably made of a soft rubber. The device attaches to a hitch by sliding it under a ball base after the nut is slightly loosed from the hitch. Once the U-shaped opening is under the ball base near the U-shaped side, the nut is tightened to hold the device in place under the ball base. The device may remain on the vehicle at all times, even during use, so a user does not have to remove and reinstall it to the tow hitch.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

In the following detailed description, reference will be made to the attached drawings in which:

FIG. 1 is a top plan view of the hitch guard of the present invention;

FIG. 2 is a side view of the arm side of the embodiment of FIG. 1;

FIG. 3 is an outer end of the embodiment of FIG. 1;

FIG. 4 is a cross sectional view of the embodiment of FIG. 1 along line 4-4; and

FIG. 5 is a side plan view of the embodiment of FIG. 1 installed on a tow hitch.

### DESCRIPTION OF PREFERRED EMBODIMENT

For purposes of describing the preferred embodiment, the terminology used in reference to the numbered components in the drawings is as follows:

| | |
|---|---|
| 1. | hitch guard |
| 2. | body |
| 3. | covering |
| 4. | opening |
| 5. | U-shaped end |
| 6. | arm side |
| 7. | hitch ball |
| 8. | pole |
| 9. | tow hitch |
| 10. | ball base |
| 11. | nut |
| 12. | tow hitch arm |
| 13. | top surface |
| 14. | bottom surface |
| 15. | locking device |
| 16. | rounded corner |

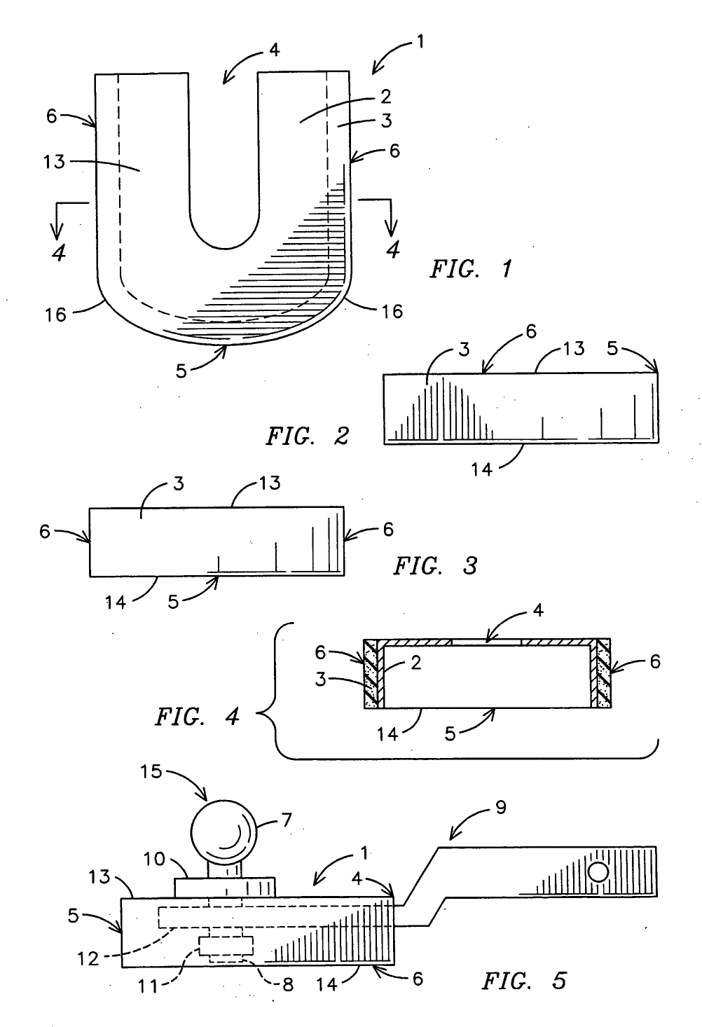

Referring to FIG. 1, the hitch guard 1 comprises a generally horseshoe shaped device having a U-shaped end 5, two arm sides 6, a top surface 13 and a central opening 4. The body 2 of the device is made of a sturdy and durable material, preferably steel, which is covered by a soft and resilient covering 3, preferably rubber. The U-shaped end 5 preferably has rounded corners 16 so as to prevent injury when a user walks into the hitch guard 1.

In FIGS. 2 and 3, differing views of the embodiment of FIG. 1 are shown. Each arm side 6 is connected to the U-shaped end 5. The bottom surface 14, arm sides 6, U-shaped end 5 and a portion of the top surface 13 are covered with a soft covering 3.

FIG. 4, depicts the body 2 of the hitch generally being formed so as to create a central opening 4 between the two arm sides 6.

FIG. 5, shows the opening 4 of the hitch guard 1 sized so as to accept the tow hitch arm 12 of a typical tow hitch 9. The typical tow hitch 9 comprises a hitch ball 7, pole 8, ball base 10 and nut 11 for use as a locking device 15 to secure the hitch guard 1 to the tow hitch 9 when the hitch guard 1 is on the tow hitch arm 12.

To use the present invention, a user simply unscrews the nut 11 to loosen the hitch ball 7, ball base 10 and pole 8 from the tow hitch arm 12. Then, the user lifts the ball 7, and thus attached ball base 10 and pole 8, to create a gap to slide the hitch opening 4 onto the tow hitch arm 12. The user inserts the pole 8 into a hole located on the tow hitch arm 12 and tightens the nut 11 so the ball base 10 is flush against the top surface 13 of the hitch guard 1. The soft rubber outer covering 3 protects a user from injury caused by bumping into the tow hitch 9. In addition, because the body 2 of the hitch guard 1 is made of a durable material, preferably steel, a user need not worry about moderate impacts damaging the shape of the tow hitch arm 12.

It is to be understood that while a certain form of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

1. A hitch guard comprising:
a rigid substantially U-shaped body having a top surface and a bottom surface;
a resilient covering located on and conforming to said body;
said body having an opening sized for accommodation of a tow hitch arm wherein said top surface overlaps at least a portion of said tow hitch arm; and
means for securing the hitch guard to the tow hitch arm.

2. The hitch guard of claim 1 wherein:
the means for securing the hitch guard comprises a tow hitch ball, pole and nut positioned so a base of the ball covers a portion of the top surface of the body.

3. The hitch guard of claim 1 wherein:
said body is steel.

4. The hitch guard of claim 1 wherein:
said covering is rubber.

5. The hitch guard of claim 3 wherein:
said covering is rubber.

6. The hitch guard of claim 1 wherein:
said rigid substantially U-shaped body has rounded corners.

7. A method for using a hitch guard comprising a substantially U-shaped body having a top surface and a bottom surface; a resilient covering located on and conforming to said body; said body having an opening sized for accommodation of a tow hitch arm wherein said top surface overlaps at least a portion of said tow hitch arm; and a means for securing the hitch guard to the tow hitch arm wherein the means for securing the hitch guard to the tow hitch arm comprises a tow hitch ball, pole and nut positioned so a base of the ball covers a portion of the top surface of the body, said method comprising the steps of:
a. loosening said nut from said pole;
b. positioning said U-shaped body such that said tow hitch arm is positioned within said opening; and
c. tightening said nut on said pole.
